(19) United States
(12) Patent Application Publication
(10) Pub. No.: US 2015/0262425 A1
(43) Pub. Date: Sep. 17, 2015

(54) ASSESSING AUGMENTED REALITY USAGE AND PRODUCTIVITY

(71) Applicants: Ryan Hastings, Seattle, WA (US); Cameron Brown, Redmond, WA (US); Nicholas Gervase Fajt, Seattle, WA (US); Daniel Joseph McCulloch, Kirkland, WA (US)

(72) Inventors: Ryan Hastings, Seattle, WA (US); Cameron Brown, Redmond, WA (US); Nicholas Gervase Fajt, Seattle, WA (US); Daniel Joseph McCulloch, Kirkland, WA (US)

(21) Appl. No.: 14/210,004

(22) Filed: Mar. 13, 2014

(51) Int. Cl. G06T 19/00; G06K 9/00; G02B 27/01

(52) U.S. Cl. CPC G06T 19/006; G02B 27/0172; G06K 9/00671; G02B 2027/0178; G06T 2219/016

(57) ABSTRACT

An augmented reality system includes a see-through display, a sensor array including one or more sensors, a logic machine, and a storage machine. The storage machine holds instructions executable by the logic machine to display via the see-through display an activity report. The activity report includes an assessment and a classification of a plurality of tasks performed by a wearer of the see-through display over a period of time. The assessment and the classification of the plurality of tasks is derived from sensor data collected from the one or more sensors over the period of time.

### BACKGROUND

Augmented reality systems provide a user an experience which includes both virtual elements and real elements within the user's physical environment. Augmented reality displays such as head-up displays and head-mounted displays may be utilized to display the virtual elements to the user in both work and entertainment settings.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

According to one aspect of this disclosure, an augmented reality system includes a see-through display, a sensor array including one or more sensors, a logic machine, and a storage machine. The storage machine includes instructions executable by the logic machine to display via the see-through display an activity report. The activity report includes an assessment and a classification of a plurality of tasks performed by a wearer of the see-through display over a period of time. The assessment and the classification of the plurality of tasks is derived from sensor data collected from the one or more sensors over the period of time.

### BRIEF DESCRIPTION OF THE DRAWINGS

FIGS. 1A and 1B illustrate example augmented reality environments in accordance with embodiments of the present disclosure.

FIGS. 2A and 2B illustrate example activity reports in accordance with embodiments of the present disclosure.

FIGS. 3A, 3B, and 3C show example suggestions in accordance with an embodiment of the present disclosure.

FIG. 4 shows a method of generating an activity report in accordance with an embodiment of the present disclosure.

FIG. 5 shows a method of generating a suggestion in accordance with an embodiment of the present disclosure.

FIG. 6 schematically shows an example head-mounted display device in accordance with an embodiment of the present disclosure.

FIG. 7 schematically shows a computing device in accordance with an embodiment of the present disclosure.

### DETAILED DESCRIPTION

Augmented reality experiences may be used to provide entertainment experiences and to enhance a user's work environment. As the line between work and entertainment narrows, it may become more important to accurately track and report a user's activity. The activity report may include productivity information to inform the user's time management and decision making.

In order to achieve the level of accuracy and fidelity in the assessment of a broad range of tasks and activities a user may perform over the course of the day, the wearable see-through display/head-mounted display (HMD) of an augmented reality system may be equipped with a suite of sensors. The sensor data may be analyzed to identify, classify, and track tasks and activities over time. Further, the sensor data may be used to compile a clear and concise assessment of productivity for the wearer of the augmented reality system.

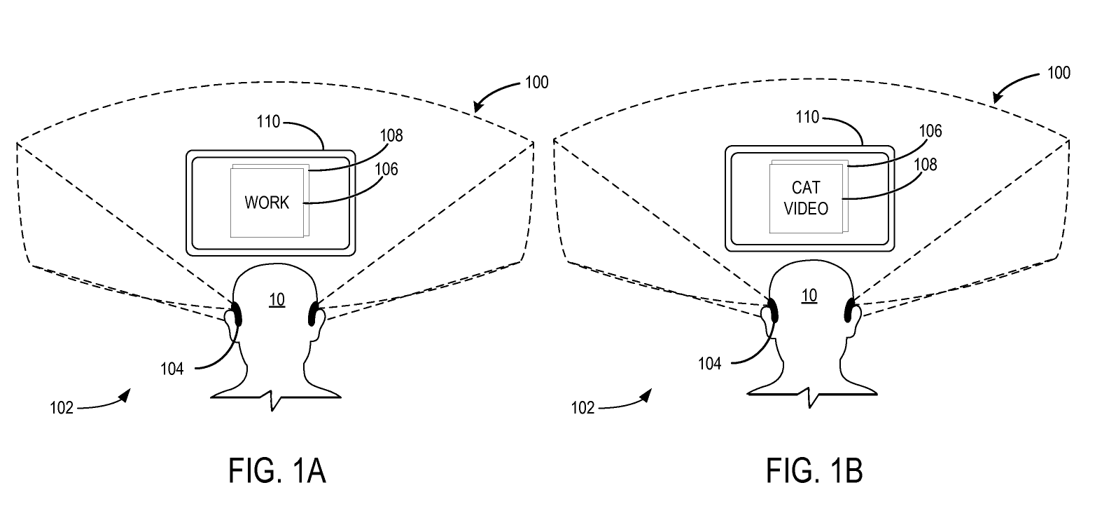

FIGS. 1A and 1B illustrate a wearer 10 of a see-through display 104 viewing an augmented reality environment 100. Augmented reality environment 100 of FIG. 1A includes a virtual windowed display 110. Work application 106 is open and active and a second, entertainment application 108 is open in the background. It will be appreciated that wearer 10 may be actively modifying the content of work application 106 or may be passively consuming, i.e., reading the content of work application 106. In this example, either actively modifying or passively consuming the content of work application 106 may be identified and classified as performance of a work-related or productive task.

In contrast, FIG. 1B shows entertainment application 108 active with work application 106 moved to the background. In this case, wearer 10 may be consuming or performing activities that may be classified as non-productive tasks. It will be appreciated that other non-productive tasks may include, but are not limited to falling asleep, looking away from virtual windowed display 110, and disabling virtual windowed display 110.

Over a given period of time, wearer 10 may switch between productive and non-productive tasks (e.g., as illustrated in FIGS. 1A and 1B). Furthermore, it will be appreciated that wearer 10 may perform a plurality of tasks and activities during the same period of time which may not involve the use of virtual windowed display 110. For example, wearer 10 may interact with a physical computing device or other physical objects within the wearer's environment. These tasks and activities may be identified and classified accordingly.

Continuing with the example above, augmented reality system 102 may identify the performance of tasks in a physical environment, augmented reality environment, and/or completely virtual environment. Augmented reality system 102 may detect the performance of a task from data received from one or more sensors. The sensor data may then be analyzed to identify the performed activity. Analysis of the sensor data to derive performed activities will be discussed in further detail below.

The identified activity may then be classified as productive or non-productive in accordance with one or more criteria. The classification criteria may be defined by crowd-sourcing/peers, wearer 10, the manufacturer of augmented reality system 102, or an employer/administrator, as nonlimiting examples.

Additionally, the sensor data may indicated an amount of time wearer 10 performs an identified task. Thus, augmented reality system 102 may assess the amount of time wearer 10 is using work application 106, entertainment application 108, and any other tasks performed during a monitored time period. Augmented reality system 102 may be configured to monitor wearer 10 for the duration of an eight hour workday, a twelve hour period, or any other suitable duration of time.

In order to accurately report to wearer 10 an accurate measure of productivity, an augmented reality system 102 including see-through display 104 may be equipped with a sensor array. The sensor array includes one or more sensors which may collect sensor data that may be used by augmented reality system 102 to identify, classify and assess each of a plurality of tasks performed by wearer 10 over a period time. The sensor array may include gaze detection sensors, a depth camera, pose sensors, image sensors, location sensors, a microphone, biometric sensors, and any other sensor that may generate sensor data indicating a task performed by wearer 10.

The sensor data collected by each sensor of the sensor array may be used singly or in combination with sensor data from one or more of the other sensors within the sensor array to identify tasks performed by wearer 10. For example, the sensor data from one or more of a gaze detection sensor, a depth camera, and an image sensor may be used to identify a plurality of tasks and/or a plurality of applications used by the wearer 10 of the see-through display 104 over the period of time. In this case, augmented reality system 102 may use the sensor data from the gaze detection sensor, depth camera and image sensor to identify when wearer 10 is using work application 106, using entertainment application 108, or looking at neither application. This combination of sensor data is advantageous in that a more accurate assessment of the activity or, in some cases, inactivity of wearer 10 may be assessed. Furthermore, passive activities such as reading may be assessed using the same combination of sensor data which can identify the location of the gaze and the target of focus of wearer 10.

As an additional example, sensor data from pose detection sensors may be used to identify motion patterns performed by wearer 10. These motion patterns may then be analyzed and matched to specific tasks that are consistent with the detected motion patterns. Thus, when wearer 10 turns his head, pose detection sensors may provide sensor data indicating the pose change of wearer 10. This pose change data may then be combined with other sensor data to determine if the cause of the pose change was part of the performance of a productive activity. For example, wearer 10 turns his head to speak with his supervisor. The pose detection sensor data may be analyzed in combination with sensor data from the image sensors and/or sensor data from the microphone. The image sensor data may then be analyzed and the supervisor identified by facial recognition. The sensor data from the microphone may be analyzed for conversation detection and voice identification. After the supervisor is identified, augmented reality system 102 may then classify the conversation as productive (in this case relating to work) or non-productive (relating to a new internet video) and assess the duration of the conversation. The conversation, its classification, and the assessed duration may then be archived and reported back to wearer 10 in an activity report.

Augmented reality system 102 may also be used to display an activity report via see-through display 104. An assessment and a classification of each of a plurality of tasks performed by wearer 10 may be included in the activity report. The assessment within the activity report may include a determination of a relative amount of time wearer 10 performs each of a plurality of tasks during the period of time the wearer is monitored. Additionally, a determination of a relative amount of time wearer 10 of the see-through display 104 uses each of the plurality of applications may be included in the activity report assessment.

As discussed above, the period of time the wearer is monitored may be configured to suit the context in which augmented reality system 102 is used. As a non-limiting example, if augmented reality system 102 is used only at the workplace of wearer 10, augmented reality system 102 may be configured to only monitor wearer 10 during working hours. In the event that augmented reality system 10 is continuously used by wearer 10, the monitoring period may be configured to monitor wearer 10 whenever see-through display 104 is worn.

Augmented reality system 102 may be further configured to provide activity reports detailing a single monitoring period or provide an aggregate report. Thus, the activity report may detail tasks performed during a work-day, a 12 hour day, a week, a month, or any requested time period. It will be further appreciated that augmented reality system 102 may be configured to output the activity report to storage.

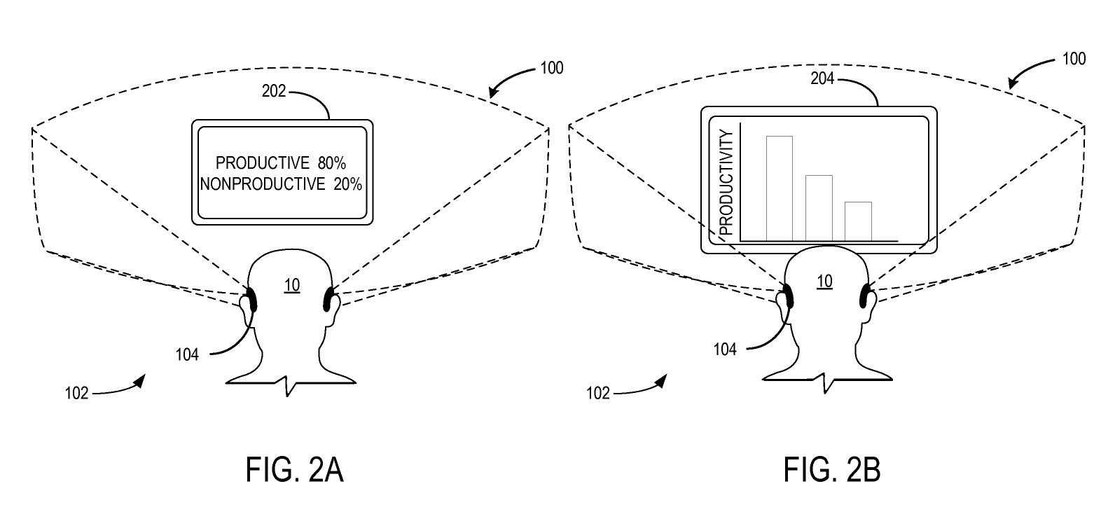

After identification, each of the plurality of tasks may then be assigned to one or more of a plurality of categories of tasks. The assessment and classification of the plurality of tasks may then be used to generate an activity report as illustrated in FIGS. 2A and 2B. FIG. 2A illustrates an activity report 202 displayed to wearer 10 in augmented reality environment 100. In this example, activity report 202 presents a coarse assessment of productive versus non-productive tasks expressed as a percentage of the total time wearer 10 performed each category of tasks.

FIG. 2B illustrates a more granular assessment of tasks performed by the user presented as a productivity bar graph 204. Each column of the bar graph may be associated to a category of task. It will be appreciated that activity report 202 and productivity bar graph 204 are non-limiting examples. The activity report may be presented to wearer 10 in any of a plurality of formats including, but not limited to, statistical, graphical, abstract, or any other suitable format selected by wearer 10.

It will be appreciated that the activity report may be delivered in electronic format to an account associated with wearer 10. The account may include electronic mail accounts, social media accounts, and any other suitable account capable of receiving the electronic activity report. The activity report may then be accessed on other devices including, but not limited to, a personal computer, smart phone, or tablet. It will be further appreciated that stored activity reports may be accessed for later review by wearer 10.

The sensor data and activity reports may be stored locally on the storage machine of augmented reality system 102 or at a remote storage machine/cloud storage. The stored sensor data and activity reports may be compiled to generate an activity profile of wearer 10. The activity profile includes historical data of performed tasks, locations visited, sensor data, social network data, and other wearer-related data that wearer 10 has authorized for collection.

The compiled data of the activity profile may be used for expanded analysis. For example, the activity profile may be analyzed to determine patterns and preferences for certain tasks, efficiency of performed tasks, and other forms of aggregate data analysis. Additional aggregate analyses may include profiling the productivity of wearer 10 over the course of a day, week, or month. Another example analysis may profile the performance efficiency of wearer 10 for a series of activities. Expanded analysis of the activity profile provides the advantages of providing wearer 10 with an accurate analysis of his productivity. Further, associative and predictive analyses may help inform his decision making. It will be appreciated that expanded analysis of the activity profile may be performed locally by the augmented reality system and/or remotely.

Naturally, any information acquired via the augmented reality system—e.g., the subject matter sighted by the wearer of the see-through display, performed tasks, and location data—may not be shared without the express consent of the wearer. Furthermore, a privacy filter may be embodied in the see-through display controller. The privacy filter may be configured to allow the reporting of productivity data within constraints—e.g., previously approved categories—authorized by the wearer, and to prevent the reporting of data outside those constraints. Productivity and task data outside those constraints may be discarded. For example, the wearer may be inclined to allow the reporting of data related to his productivity at work or while working remotely, but the wearer may not allow data relating to his social life to be reported. The privacy filter additionally or alternatively may anonymize data. In this manner, the privacy filter may allow for consumption of productivity data in a way that safeguards the privacy of the see-through display wearer.

Augmented reality system 102 may use the data within the activity profile in addition to analysis of sensor data received from the sensor array to display a recommendation on see-through display 104. The recommendation may include one or more tasks that may be performed by wearer 10. Furthermore, augmented reality system 102 may activate one or more applications associated with the recommendation.

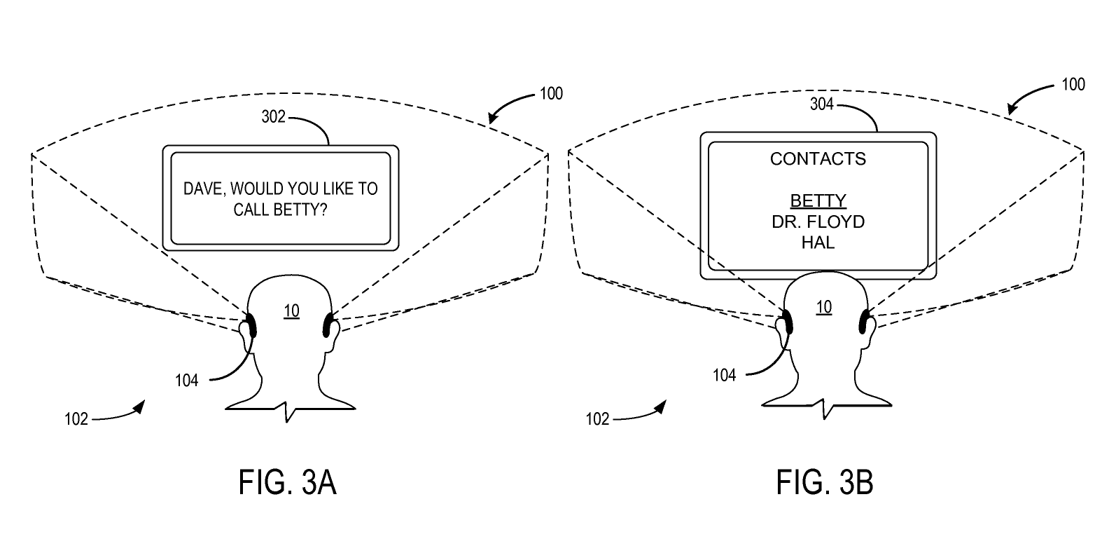

As a non-limiting example, FIG. 3A illustrates a recommendation 302 for wearer 10 to call an associate. Recommendation 302 may be generated from pattern-based analysis of the activity profile and, in this example, identifying that after performing a specific task, wearer 10 historically calls that particular associate. Recommendation 302 may be displayed on see-through display 104 within augmented reality environment 100. Alternatively, recommendation 302 may be delivered via audio or any other suitable means. FIG. 3B illustrates augmented reality system 102 activating and displaying contact menu 304 associated with recommendation 302 in FIG. 3A. Wearer 10 may then acknowledge the recommendation and select the appropriate contact. Augmented reality system 102 may then interface with the phone of wearer 10 to place the call.

It will be appreciated that augmented reality system 102 may interface with other third party applications and other computing devices to retrieve data that may be required to generate a recommendation. As non-limiting examples, the augmented reality system may interface with social media applications, traffic and weather applications, calendar and scheduling applications, and any other application that may provide relevant information to the wearer.

As an additional example, FIG. 3C illustrates augmented reality device 102 generating and displaying a proactive recommendation 308. In this case, augmented reality system 102 identifies that wearer 10 is in his automobile. Furthermore, augmented reality system 102 may determine the geographic location of wearer 10 as well as sensor data indicating the route wearer 10 is driving. Augmented reality system may then predict a most likely destination, obtain local traffic information, and calculate an estimated time of the commute. Then, augmented reality system 102 may determine one or more appropriate tasks that may be performed during the commute.

As illustrated in FIG. 3C, augmented reality system 102 has identified that the automobile is not in motion and at a stop light. It will be appreciated that augmented reality system 102 may use sensor data from GPS sensors, cellular networks, and available WiFi networks to geographically locate wearer 10. Imaging sensors may be used to visually identify the interior of the automobile and the stoplight 310. Inertial sensors may provide sensor data indicating the current speed of the automobile or, in this case, that the automobile is stopped. It will be further appreciated that augmented reality system 102 may use geographical position to account for local ordinances in the generation of appropriate tasks within proactive recommendation 308.

At this appropriate point, augmented reality system 102 may then display proactive recommendation 308 on see-through display 104. It will be appreciated that proactive recommendation 308 may be output with an audio prompt, solely as an audio prompt, or in any other suitable format dependent on the current state of the wearer. Additionally, augmented reality system 102 may identify device interface systems within the automobile. The presence of a device interface system may also be used to determine the appropriate tasks within proactive recommendation 308 and, when appropriate, may be used for delivery of proactive recommendation 308.

It will be appreciated that the data sources, types of recommendation, and format of the recommendation may be updated automatically by analysis of the activity profile. Furthermore, the wearer of the see-through display may manually configure the augmented reality system with preferred data sources, recommendation types, and notification formats.

The configurations described above enable various methods to measure productivity and task performance of a wearer of a see-through display of an augmented reality system. Some such methods are now described, by way of example, with continued reference to the above configurations. It will be understood, however, that the methods here described, and others within the scope of this disclosure, may be enabled by different configurations as well. The methods herein, which involve the observation of people in their daily lives, may and should be enacted with utmost respect for personal privacy. Accordingly, the methods presented herein are fully compatible with opt-in participation of the persons being observed. In embodiments where personal data is collected on a local system and transmitted to a remote system for processing, that data can be anonymized. In other embodiments, personal data may be confined to a local system, and only non-personal, summary data transmitted to a remote system.

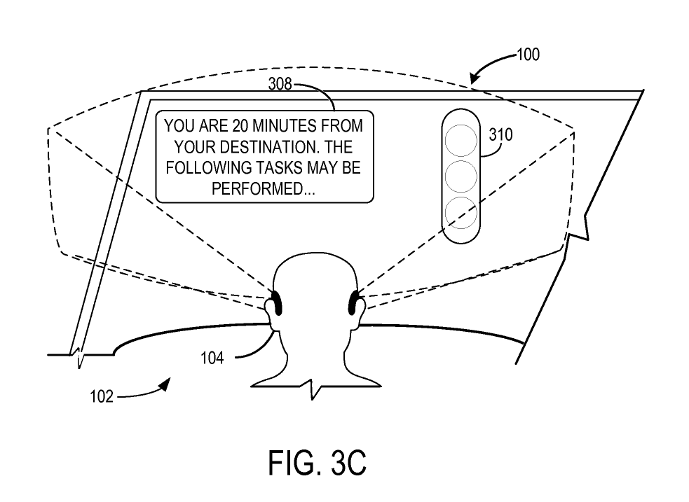

FIG. 4 shows a method 400 for assessing augmented reality usage. It will be appreciated that method 400 may be performed locally in its entirety using the logic machine and storage machine of the augmented reality system or the sensor data may be partially or fully processed by a remote/cloud-based computing device.

At 402, method 400 includes receiving sensor data from the sensor array. As discussed above with reference to FIGS. 1A and 1B, the sensor data may indicate the performance of a task or may indicate a period of inactivity by the wearer of the see-through display. At 404, method 400 identifies from the received sensor data a plurality of tasks performed during a period of time by the wearer of a see-through display.

In the event that the received sensor data is ambiguous and a task cannot be reliably identified from the sensor data alone, method 400 may proceed to 406. At 406, method 400 includes the augmented reality system querying the wearer of the see-through display for additional information about a performed task. The augmented reality system may display the query on the see-through display or may deliver the query via another suitable mechanism (e.g., audio). It will be appreciated that the query may also be delivered to an account associated with the wearer of the see-through display (e.g., email survey).

At 408, method 400 includes classifying each of the plurality of tasks identified from the received sensor data. Each identified task may be assigned one or more of a plurality of categories. These categories may be defined by default settings, the wearer of the see-through display, an administrator, or by any suitable means. As examples, the categories may be broad and encompass productive and non-productive tasks. Furthermore, the categories may be more specific such as breaking down productive tasks into writing applications, reading references, teleconferencing, and mowing the lawn. Non-productive tasks may be further classified into entertainment websites, staring into space, watching movies/television, and gossiping with co-workers. The detail of the categorization may have virtually any level of granularity.

At 410, method 400 includes assessing a relative amount of time the wearer of the see-through display performs each of the plurality of tasks identified from the sensor data. An exact time duration for each performed task optionally may be assessed. As described above for classification of tasks, the detail of the assessment and the period of time may be configured by the wearer, an administrator, or remain at a manufacturer's default setting. In this manner, the assessment of performed tasks may reflect the preferences of the wearer and/or another authority. Therefore, the assessment may be advantageously configured to provide an efficient and meaningful reporting of the tasks performed by the wearer of the see-through display.

At 412, method 400 further includes identifying and classifying a plurality of applications used during the relevant period of time. Such identification and classification may be derived from sensor data received from a plurality of sensors. As an additional example, the sensor data may indicate the wearer is using a highly configurable application. The sensor data may then be used to identify the application and to determine the configuration of the application. The configuration data may then be used to pre-configure the application on future use of the application. Furthermore, the application configuration data may also be used for productivity analysis. For example, the configuration data may be associatively processed with the assessment data for a task where the application is used. The configuration for the application that resulted in high productivity or efficiency may be identified and stored for future use by the wearer.

At 414, method 400 includes outputting an activity report including an assessment and classification of each of the plurality of tasks performed by the wearer of the see-through display in the relevant period of time. At 416, method 400 includes displaying the activity report to a wearer of the see-through display. Alternatively, at 418, method 400 includes delivering the activity report in electronic format to an account associated with a wearer of the see-through display. As discussed above, the account may be any suitable account that may receive the activity report and is authorized by the wearer. It will also be appreciated that the activity report may be output to local or remote storage.

Furthermore, at 420, method 400 includes analyzing the identification and assessment of the plurality of tasks within the activity report and outputting a recommendation including one or more tasks identified within the activity report. For example, the augmented reality system may review the tasks completed by the wearer of the see-through display and generate recommendations based upon what the wearer has performed and any remaining tasks the wearer has scheduled.

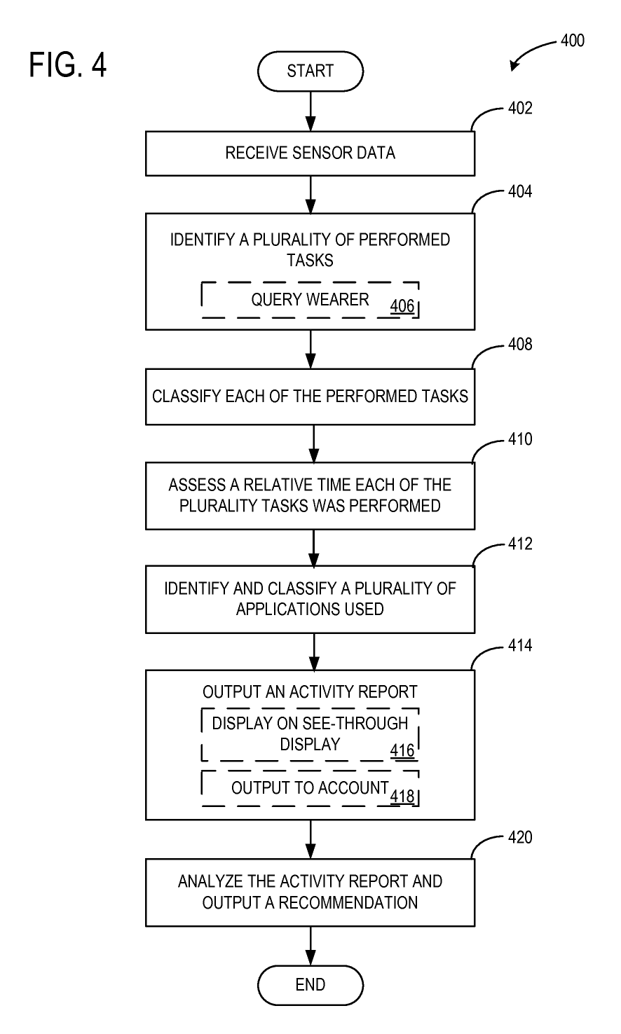

FIG. 5 shows a method for assessing augmented reality usage and generating recommendations as illustrated in FIGS. 3A, 3B, and 3C. It will be appreciated that method 500 may be performed locally by the augmented reality system, at a remote computer in communication with the augmented reality system, or cooperatively by the augmented reality device and the remote computer. At 502, method 500 includes retrieving a plurality of activity reports, each activity report including an identification and assessment of tasks performed by a wearer of an augmented reality system. The activity reports may be retrieved from local or remote storage.

At 504, method 500 includes identifying a pattern of performance of the tasks performed by the wearer. At 506, method 500 includes identifying a preference of tasks performed by the wearer. Pattern and preference based analysis of the retrieved activity reports allows the augmented reality system to personalize the recommendations delivered to the wearer of the see-through display.

At 508, method 500 includes assembling a productivity profile from the plurality of activity reports. The productivity profile may include the pattern and preference data from 506 and 508, as well as data retrieved from first party and third party applications.

At 512, method 500 includes extrapolating from the pattern of performance, preference of tasks, and the productivity profile, a recommendation including one or more tasks that may be optimally performed by the wearer. As discussed above, the recommendation may be based upon identified patterns and preferences, the wearer's schedule, and/or any other suitable productivity metric such as efficiency of a performed task. Additional associative processing of the productivity profile data may yield recommendations based upon a calculated efficiency of the performance of a specific task relative to the time of day, day of the week, current location, or tasks performed prior to the performance of that specific task. For example, analysis of the productivity profile may indicate that the wearer is more efficient when reading reports between 10:00 AM and 12:00 PM and while located in the workplace. Thus, if the wearer is at work and the current time is 11:30 AM, a recommendation to read a report may be generated and delivered to the wearer. However, if the wearer were at home, another task which the wearer performs more efficiently at home may be recommended.

Furthermore, method 500 may include determining a current physical condition and a current environment of the wearer from the sensor data received at 510 and outputting one or more tasks that are appropriate to the current physical condition and the current environment of the wearer of the augmented reality system. For example, the augmented reality system may determine from received biometric data that the wearer is experiencing high stress levels. The augmented reality system may then generate a recommendation of a task more suitable to the wearer's current condition. As another example, sensor data may indicate that the wearer is in an automobile beginning a drive home. Analysis of the activity profile and schedule data may indicate that the wearer has a phone call remaining to be performed. Furthermore, the augmented reality system may further determine that an average duration of similar, previous phone calls is less than the transit time of the wearer to drive home. The augmented reality system may then interface with the wearer's smart phone and/or automobile to facilitate the call prior to delivering the recommendation to the wearer.

At 514, method 500 includes outputting the recommendation to the wearer. The recommendation may be displayed on the see-through display at 516. It will also be appreciated that outputting the recommendation may optionally include delivering the recommendation as an audio prompt or a combination of displaying the recommendation and audio prompt.

At 518, method 500 may additionally include activating one or more applications associated with the recommendation. Optionally, the augmented reality device may activate the application in lieu of displaying the recommendation. The applications activated by the augmented reality system may include first party and third party applications. For example, augmented reality device may activate applications to inform the wearer that a recommendation is available, or activate an application required for the performance of a task within the recommendation. It will be appreciated that activating an application may include establishing an interface connection between the augmented reality system and any available interface devices. As an example, the augmented reality device may interface with the wearer's cellular phone to facilitate a recommended phone call.

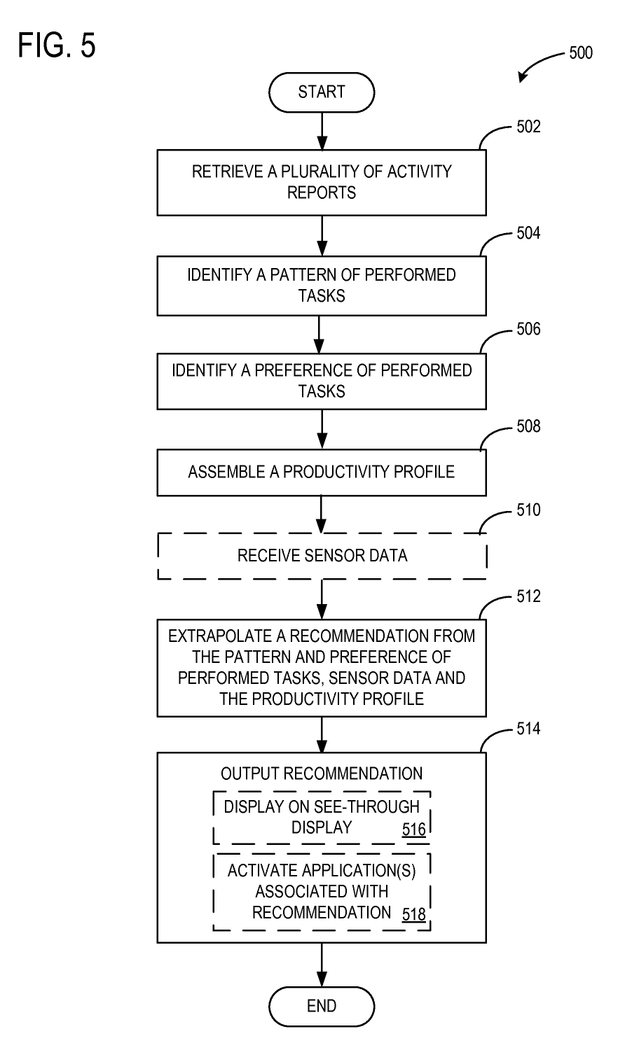

With reference now to FIG. 6 one example of a see-through display/HMD device 600 in the form of a pair of wearable glasses with a transparent display 602 is provided. It will be appreciated that in other examples, the HMD device 600 may take other suitable forms in which a transparent, semi-transparent, and/or non-transparent display is supported in front of a viewer's eye or eyes. It will also be appreciated that the see-through display 104 shown in FIGS. 1A and 1B may take the form of the HMD device 600, as described in more detail below, or any other suitable HMD device.

The HMD device 600 includes a display system 604 and transparent display 602 that enables images such as holographic objects to be delivered to the eyes of a wearer of the HMD. The transparent display 602 may be configured to visually augment an appearance of a physical environment to a wearer viewing the physical environment through the transparent display. For example, the appearance of the physical environment may be augmented by graphical content (e.g., one or more pixels each having a respective color and brightness) that is presented via the transparent display 602 to create an augmented reality environment. As another example, transparent display 602 may be configured to render a fully opaque virtual environment.

The transparent display 602 may also be configured to enable a user to view a physical, real-world object in the physical environment through one or more partially transparent pixels that are displaying a virtual object representation. As shown in FIG. 6, in one example the transparent display 602 may include image-producing elements located within lenses 606 (such as, for example, a see-through Organic Light-Emitting Diode (OLED) display). As another example, the transparent display 602 may include a light modulator on an edge of the lenses 606. In this example the lenses 606 may serve as a light guide for delivering light from the light modulator to the eyes of a user. Such a light guide may enable a user to perceive a 3D holographic image located within the physical environment that the user is viewing, while also allowing the user to view physical objects in the physical environment, thus creating an augmented reality environment.

The HMD device 600 may also include various sensors and related systems. For example, the HMD device 600 may include a gaze tracking system 608 that includes one or more image sensors configured to acquire image data in the form of gaze tracking data from a user's eyes. Provided the user has consented to the acquisition and use of this information, the gaze tracking system 608 may use this information to track a position and/or movement of the user's eyes.

In one example, the gaze tracking system 608 includes a gaze detection subsystem configured to detect a direction of gaze of each eye of a user. The gaze detection subsystem may be configured to determine gaze directions of each of a user's eyes in any suitable manner. For example, the gaze detection subsystem may comprise one or more light sources, such as infrared light sources, configured to cause a glint of light to reflect from the cornea of each eye of a user. One or more image sensors may then be configured to capture an image of the user's eyes.

Images of the glints and of the pupils as determined from image data gathered from the image sensors may be used to determine an optical axis of each eye. Using this information, the gaze tracking system 608 may then determine a direction the user is gazing. The gaze tracking system 608 may additionally or alternatively determine at what physical or virtual object the user is gazing. Such gaze tracking data may then be provided to the HMD device 600.

It will also be understood that the gaze tracking system 608 may have any suitable number and arrangement of light sources and image sensors. For example and with reference to FIG. 6, the gaze tracking system 608 of the HMD device 600 may utilize at least one inward facing sensor 609.

The HMD device 600 may also include sensor systems that receive physical environment data from the physical environment. For example, the HMD device 600 may also include a head tracking system 610 that utilizes one or more motion sensors, such as motion sensors 612 on HMD device 600, to capture head pose data and thereby enable position tracking, direction and orientation sensing, and/or motion detection of the user's head.

Head tracking system 610 may also support other suitable positioning techniques, such as GPS or other global navigation systems. Further, while specific examples of position sensor systems have been described, it will be appreciated that any other suitable position sensor systems may be used. For example, head pose and/or movement data may be determined based on sensor information from any combination of sensors mounted on the wearer and/or external to the wearer including, but not limited to, any number of gyroscopes, accelerometers, inertial measurement units (IMUs), GPS devices, barometers, magnetometers, cameras (e.g., visible light cameras, infrared light cameras, time-of-flight depth cameras, structured light depth cameras, etc.), communication devices (e.g., WIFI antennas/interfaces), etc.

In some examples the HMD device 600 may also include an optical sensor system that utilizes one or more outward facing sensors, such as optical sensor 614 on HMD device 600, to capture image data. The outward facing sensor(s) may detect movements within its field of view, such as gesture-based inputs or other movements performed by a user or by a person or physical object within the field of view. The outward facing sensor(s) may also capture 2D image information and depth information from the physical environment and physical objects within the environment. For example, the outward facing sensor(s) may include a depth camera, a visible light camera, an infrared light camera, and/or a position tracking camera.

The optical sensor system may include a depth tracking system that generates depth tracking data via one or more depth cameras. In one example, each depth camera may include left and right cameras of a stereoscopic vision system. Time-resolved images from one or more of these depth cameras may be registered to each other and/or to images from another optical sensor such as a visible spectrum camera, and may be combined to yield depth-resolved video.

In other examples a structured light depth camera may be configured to project a structured infrared illumination, and to image the illumination reflected from a scene onto which the illumination is projected. A depth map of the scene may be constructed based on spacings between adjacent features in the various regions of an imaged scene. In still other examples, a depth camera may take the form of a time-of-flight depth camera configured to project a pulsed infrared illumination onto a scene and detect the illumination reflected from the scene. For example, illumination may be provided by an infrared light source 616. It will be appreciated that any other suitable depth camera may be used within the scope of the present disclosure.

The outward facing sensor(s) may capture images of the physical environment in which a user is situated. With respect to the HMD device 600, in one example a mixed reality display program may include a 3D modeling system that uses such captured images to generate a virtual environment that models the physical environment surrounding the user.

The HMD device 600 may also include a microphone system that includes one or more microphones, such as microphone 618 on HMD device 600, that capture audio data. In other examples, audio may be presented to the user via one or more speakers, such as speaker 620 on the HMD device 600.

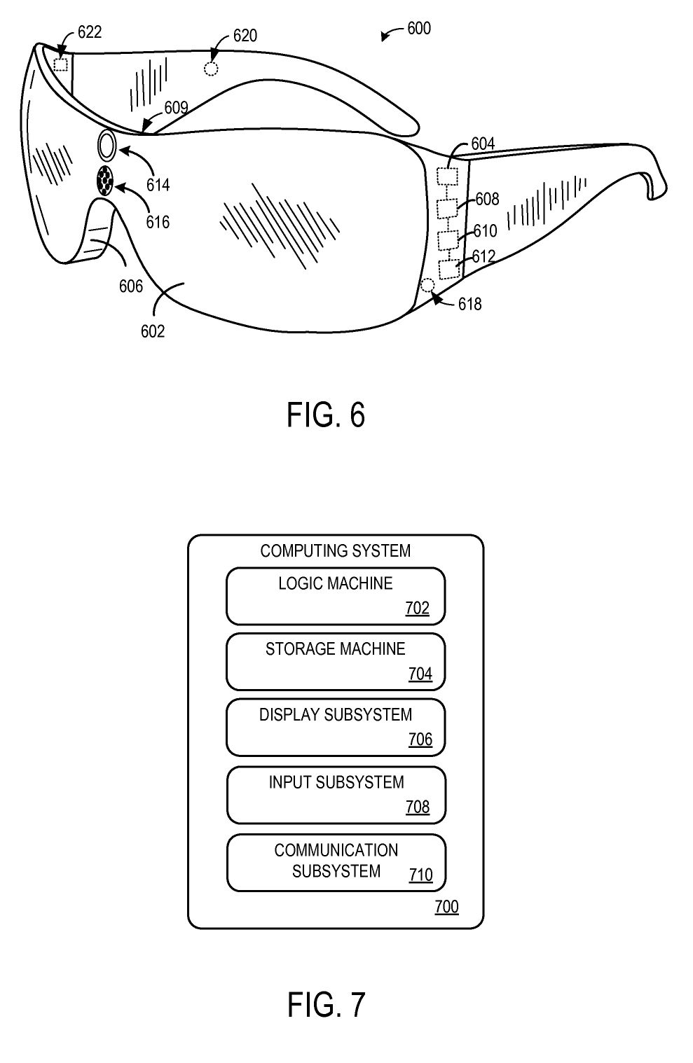

The HMD device 600 may also include a controller, such as controller 622 on the HMD device 600. The controller may include a logic machine and a storage machine, as discussed in more detail below with respect to FIG. 7, that are in communication with the various sensors and systems of the HMD device and display. In one example, the storage subsystem may include instructions that are executable by the logic subsystem to receive sensor data from the sensors and identify a plurality of performed tasks by the wearer of HMD device 600.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 7 schematically shows a non-limiting embodiment of a computing system 700 that can enact one or more of the methods and processes described above. Computing system 700 is shown in simplified form. Computing system 700 may take the form of one or more head-mounted display devices, or one or more devices cooperating with a head-mounted display device (e.g., personal computers, server computers, tablet computers, home-entertainment computers, network computing devices, gaming devices, mobile computing devices, mobile communication devices (e.g., smart phone), and/or other computing devices).

Computing system 700 includes a logic machine 702 and a storage machine 704. Computing system 700 may optionally include a display subsystem 706, input subsystem 708, communication subsystem 710, and/or other components not shown in FIG. 7.

Logic machine 702 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 704 includes one or more physical devices configured to hold machine-readable instructions executable by the logic machine to implement the methods and processes described herein. When such methods and processes are implemented, the state of storage machine 704 may be transformed—e.g., to hold different data.

Storage machine 704 may include removable and/or built-in devices. Storage machine 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 704 may include volatile, nonvolatile, dynamic, static, read/write, read-only, random-access, sequential-access, location-addressable, file-addressable, and/or content-addressable devices.

It will be appreciated that storage machine 704 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 702 and storage machine 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 706 may be used to present a visual representation of data held by storage machine 704. This visual representation may take the form of a graphical user interface (GUI). As the herein described methods and processes change the data held by the storage machine, and thus transform the state of the storage machine, the state of display subsystem 706 may likewise be transformed to visually represent changes in the underlying data. Display subsystem 706 may include one or more display devices utilizing virtually any type of technology, such as displays 602 of the HMD 600 illustrated in FIG. 6. Such display devices may be combined with logic machine 702 and/or storage machine 704 in a shared enclosure, or such display devices may be peripheral display devices.

When included, input subsystem 708 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; electric-field sensing componentry for assessing brain activity; any of the sensors described above with respect to head tracking system 610 of FIG. 6; and/or any other suitable sensor.

When included, communication subsystem 710 may be configured to communicatively couple computing system 700 with one or more other computing devices. Communication subsystem 710 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 700 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. An augmented reality system, comprising:
a see-through display;
a sensor array including one or more sensors;
a logic machine; and
a storage machine holding instructions executable by the logic machine to:
display via the see-through display an activity report including an assessment and a classification of a plurality of tasks performed by a wearer of the see-through display over a period of time, the assessment and the classification of the plurality of tasks derived from sensor data collected from the one or more sensors over the period of time.

2. The augmented reality system of claim 1, wherein the sensor data from one or more of a gaze detection sensor, a depth camera, and an image sensor is useable to identify a plurality of tasks performed by the wearer of the see-through display over the period of time.

3. The augmented reality system of claim 1, wherein assessing the plurality of tasks performed by the wearer of the see-through display includes determining a relative amount of time the wearer of the see-through display performs each of the plurality of tasks.

4. The augmented reality system of claim 1, wherein classifying the plurality of tasks performed by the wearer of the see-through display includes assigning each of the plurality of tasks to one or more of a plurality of categories.

5. The augmented reality system of claim 1, wherein the sensor data from one or more of a gaze detection sensor, a depth camera, and an image sensor is useable to identify a plurality of applications used by the wearer of the see-through display over the period of time.

6. The augmented reality system of claim 5, wherein the storage machine holds instructions executable by the logic machine to determine a relative amount of time the wearer of the see-through display uses each of the plurality of applications.

7. The augmented reality system of claim 1, wherein the storage machine holds instructions executable by the logic machine to analyze the sensor data and display a recommendation on the see-through display.

8. The recommendation of claim 7, wherein the recommendation includes one or more tasks currently performable by the wearer of the see-through display.

9. The augmented reality system of claim 7, wherein the storage machine holds instructions executable by the logic machine to activate one or more applications associated with the recommendation.

10. The augmented reality system of claim 1, wherein the activity report is delivered to an account associated with the wearer of the see-through display.

11. A method of assessing augmented reality usage, the method comprising:
identifying a plurality of tasks performed during a period of time by a wearer of a see-through display;
classifying each of the plurality of tasks;
assessing a relative time the wearer performs each of the plurality of tasks; and
outputting an activity report including an assessment and classification of each of the plurality of tasks performed by the wearer of the see-through display in the period of time.

12. The method of claim 11, wherein the plurality of tasks performed during the period of time is identified from sensor data received from a plurality of sensors.

13. The method of claim 11, wherein identifying the plurality of tasks further includes querying the wearer of the see-through display for additional information about a performed task.

14. The method of claim 11, wherein classifying the plurality of tasks includes assigning each of the plurality of tasks to one or more of a plurality of categories.

15. The method of claim 11, further comprising identifying and classifying a plurality of applications used during the period of time from sensor data received from a plurality of sensors.

16. The method of claim 11, wherein outputting the activity report includes displaying the activity report to a wearer of a see-through display.

17. The method of claim 11, wherein outputting the activity report includes delivering the activity report in electronic format to an account associated with a wearer of a see-through display.

18. The method of claim 11, further comprising analyzing the identification and assessment of the plurality of tasks within the activity report and outputting a recommendation including one or more tasks.

19. A method of assessing augmented reality usage, the method comprising:
retrieving a plurality of activity reports each including an identification and assessment of tasks performed by a wearer of an augmented reality system;
identifying a pattern of performance of the tasks performed by the wearer;
identifying a preference of tasks performed by the wearer;
assembling a productivity profile from the plurality of activity reports;
extrapolating from the pattern of performance, preference of tasks, and the productivity profile a recommendation including one or more tasks that may be performed by the wearer; and
outputting the recommendation to the wearer.

20. The method of claim 19, wherein extrapolating the recommendation further includes determining a current physical condition and a current environment of the wearer from the sensor data received from a plurality of sensors and outputting one or more tasks that are appropriate to the current physical condition and the current environment of the wearer of the augmented reality system.
